(19) United States
(12) Patent Application Publication
(10) Pub. No.: US 2009/0278870 A1
(43) Pub. Date: Nov. 12, 2009

(54) Method of Displaying Pixels Using Fractional Pulse Width Modulation

(75) Inventor: DAVID L. MEDIN, Los Altos, CA (US)

Correspondence Address: FISH & RICHARDSON P.C., PO BOX 1022, MINNEAPOLIS, MN, 55440-1022, US

(73) Assignee: Spatial Photonics, Inc., Sunnyvale, CA (US)

(21) Appl. No.: 12/118,916

(22) Filed: May 12, 2008

(51) Int. Cl. G09G 5/10

(52) U.S. Cl. 345/691

(57) ABSTRACT

A method for displaying a pixel on a display system using a series of digital pulses obtained by first determining a minimum pulse width (MPW) capable of displaying a pixel on the display system and then using a series of pulses for the display of the pixel, where at least some of the pulses have different pulse widths, and where at least one pulse has a width that is a non-integer multiple greater than 1 of the MPW. In this way, the number of unique intensity levels of the pixels of the displayed image can be increased and display resolution is improved. Even better resolution is obtained using two different, alternating series of digital pulses.

### BACKGROUND

Micro-mirror displays have become common for use in business projectors, TV video projectors for home theater and rear-projection TVs. The display is created by a semiconductor micro-mirror device that displays pixels by deflecting light at different angles using tilting micro-mirrors. When the mirror is in one position, light is deflected to the display so as display a pixel; in the other position, light is deflected away from the display and the pixel is not displayed.

Digital control signals are used to deflect the micro-mirrors of a micro-mirror display, as well to control the display elements of other displays, such as plasma and LCoS. These digital control signals operate in two states: the “on” state where the light is directed onto the viewing area; the “off” state where the light is kept away from the viewing area. The percentage of time the device places the light in the “on” state versus in the “off” state determines the perceived brightness level of the pixel display—between black (all off) and white (all on). The number of possible light levels of a pixel between black and white during a given modulation time period is a function of the time period for display of the pixel, divided by the shortest modulation increment.

The shortest modulation increment is also called the minimum pulse width (MPW) or the least significant bit (LSB). The MPW is determined by two factors: (1) the data transfer rate (the time required to send pixel data to the display); and (2) the pixel switching time (the time required for the pixel element to change states).

Digital control signals are commonly pulse width modulated. Pulse-width modulation (PWM) uses a square wave whose duty cycle is modulated, resulting in a variation of the average value of the waveform. There are numerous ways to implement PWM. As shown in prior art FIG. 1, the same modulation patterns can be realized using either 64 equally weighted states (each state is identified by the number “1” in pulse chain 8), or using six binary-weighted states (illustrated by the binary states of 1, 2, 4, 8, 16 and 32 in pulse chain 9). In both of these examples, the smallest time increment MPW or LSB=1. In either the equally or binary weighted cases, the resolution of the display is determined by the smallest possible time increment, the MPW or LSB.

One example of a display system is an RGB, field-sequential, LED-based micro-mirror display with a 60 Hz video source. At 60 Hz, the display is refreshed or changed each 1/60 second, or every 16.67 ms. As these RGB systems have three LEDs, one red, one green and one blue, the R, G and B fields are displayed sequentially, hence the name “field-sequential.” The percentage of time allocated for each of the red, green and blue LEDs is a function of many variables including LED efficiency and user preference.

If each field is on for about ⅓ of the time, the time available for refreshing each field would be one third of the refresh rate, or ⅓*16.67 ms, that equals 5.55 ms, which is about 5500 μs. In a micro-mirror system, to achieve 8-bit resolution in this example, the system must be able to modulate the micro-mirrors at 5500 μs/(2⁸−1)=5500 μs/255=21.6 μs. 9-bit resolution would require an LSB of 5500 μs/(2⁹−1)=5500 μs/511=10.8 μs. For each additional bit of resolution, the LSB time would need to be halved. For a given PWM-based display system and video frame rate, the maximum resolution is determined by the minimum time allocated for modulation. As discussed above, this minimum modulation or switching time must take into account not only the electrical time it takes the signal to reach the display, but also the physical properties of the system (the time it takes to actually move the mirror of a micro-mirror device or to switch the opacity of an LCoS device).

In most PWM systems, optimal resolution cannot be achieved within the practical constraints of the system. As an example, most broadcast video content uses a non-linear scaling factor, referred to as a gamma. Gamma is an internal adjustment applied to compensate intensities in imaging systems. This non-linear scaling factor in broadcast video increases the resolution in the dark areas, where the signal is more susceptible to noise, but reduces resolution in the bright white areas where the eye is less sensitive to contouring.

Prior art CRT and LCD displays are often designed with a gamma of 2.2, generally using analog techniques to map the non-linearly (i.e., 2.2) spaced 256 levels (i.e., LSBs) of an 8-bit image onto the display—without requiring increased processing resolution or suffering visible resolution loss. If the video content has 10 bits of resolution, there are 1024 non-linearly spaced levels or LSBs. However, digital PWM systems are linear in nature so they require significantly higher resolution than that of the video content to accurately display the image and to avoid visible contouring on the display, especially in the dark areas.

FIG. 2 (prior art) illustrates the difference between mapping an 8-bit video signal with a gamma of 2.2 to an 8-bit linear signal, and mapping the same video signal to a 12-bit linear signal. The mapping to an 8-bit resolution clearly shows the “jaggies” where the resolution of the 8-bit linear signal is inadequate to accurately reproduce the resolution of a gamma 2.2 signal. However, the higher resolution, 12-bit linear signal is capable of a producing a more accurate representation of the 8-bit video signal with a gamma of 2.2.

In addition, many PWM-based display systems depend upon temporal and/or spatial dithering to increase the perceived resolution. Unfortunately, dithering creates other undesirable visual artifacts, particularly where the objects in the image are moving. Spatial dithering is most effective in darker scenes where the eye integrates the value of a region of pixels with less sensitivity to the dither patterns, but often creates annoying artifacts in brighter scenes. Thus, even if some dithering is required, it is highly desirable to keep it to a minimum, and preferably confined to the darker areas.

The details of one or more embodiments of the invention are set forth in the accompanying drawings and the description below. Other features, objects, and advantages of the invention will be apparent from the description and drawings, and from the claims.

### SUMMARY

This invention relates to a method for displaying a pixel on a display system using a series of digital pulses. The series of pulses is obtained by first determining a minimum pulse width (MPW) capable of displaying a pixel on the display system. Then a series of pulses for the display of the pixel is defined so that at least some of the pulses have different pulse widths, where at least one pulse has a width which is a non-integer multiple greater than 1 of the MPW. In this way, the number of unique intensity levels of the pixels of the displayed image can be increased.

In another aspect, the invention uses a first series of pulses interleaved with a second series of pulses, where each series of pulses has at least some of the pulses in the series of different pulse widths, and where at least one pulse in each series has a pulse width which is a non-integer multiple, greater than 1, of the MPW. The first and second series of pulses are different from each other, whereby the pixels of the displayed image can have a larger number of unique intensity levels and the displayed image can have an improved resolution. In other aspects of the invention, the pulse width sequence of at least one of the two series of pulses varies over time.

In another aspect of the invention, spatial or temporal dithering of the series of pulses is used.

The non-integer multiples of the MPW in a PWM system are used to increase the effective resolution of codes between the LSB and the maximum code value. Therefore the display technique of the invention can be referred to as “fractional PWM.” This technique increases the resolution of a PWM system for a given modulation time period and LSB time increment.

### DESCRIPTION OF DRAWINGS

FIG. 1 (prior art) is a time chart of a prior art method of PWM;

FIG. 2 (prior art) is a graph illustrating prior art PWM using 8-bit and 12-bit linear resolution to display a non-linear video signal having a gamma of 2.2 on a linear display;

FIG. 3 illustrates a fractional PWM technique of the invention using ½ⁿ increments of the LSB when n=1 to 3;

FIG. 4 illustrates a fractional PWM technique of the invention using 1/10 increments of the LSB;

FIG. 5 illustrates a fractional PWM technique of the invention using different pulse sequences for odd and even frames;

FIG. 6 illustrates the fractional PWM technique of the invention using different pulse sequences for odd and even frames and using different fractional weighing over time;

FIG. 7 is a graph comparing 8-bit PWM of the prior art with 11-bit resolution fractional PWM of the invention to display a non-linear video signal having a gamma of 2.2 on a linear display; and

FIG. 8 is a graph showing the fractional PWM technique of the invention shown in FIG. 6, using 11-bit resolution, along with dithering part of the image to display a non-linear video signal having a gamma of 2.2 on a linear display.

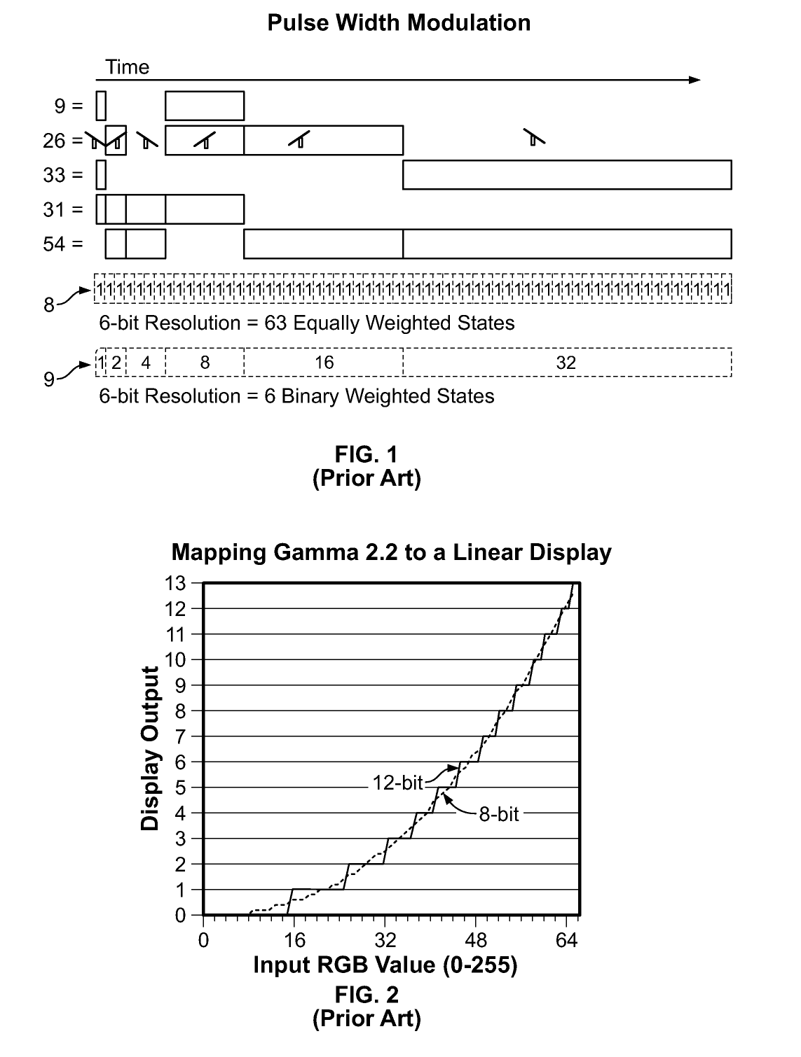

Like reference symbols in the various drawings indicate like elements.

### DETAILED DESCRIPTION

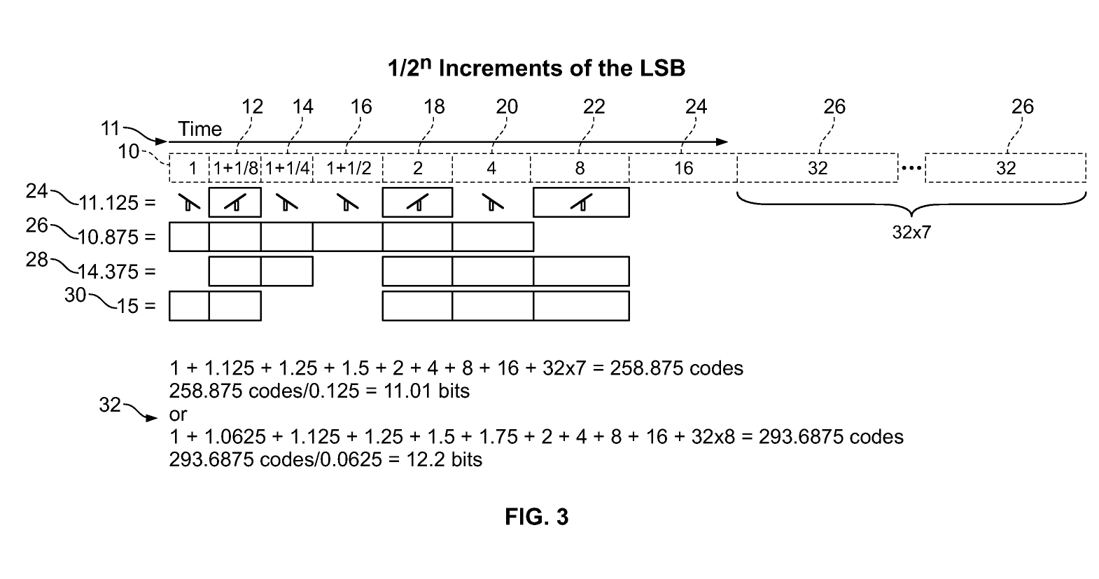

Referring to FIG. 3, a time line 11 is shown with a series of pulse segments employing fractional PWM of the invention. The first segment 10 of the time line is the minimum pulse width (MPW) which is set to be 1 unit of time. If, for example, the MPW is 10 μs, than a “1” is represented by a 10 μs pulse. The next segment 12 is 1⅛ times the length of the MPW, or 11.25 μs. The next segment 14 is 1¼ the length of the MPW or 12.5 μs. The fourth segment 16 is 1½ the length or 15 μs. Segments 18, 20, 22 and 24 are respectively segments of lengths 2*MPW, 4*MPW, 8*MPW and 16*MPW, respectively. Segments 26, of which there are actually seven, are each 32*MPW.

Using a micro-mirror display, during each of the time intervals represented by segments 10 through 22, a mirror controlled by the PWM signal of FIG. 3 can switch the displayed pixel from the on state to the off state, or vice-versa. Thus a mirror can switch positions six times, once between segments 10 and 12, once between segments 12 and 14, once between segments 14 and 16, once between segments 16 and 18, once between segments 18 and 20, and once between segments 20 through 22. The mirror can also switch 8 more times in the intervals between segment 22 and any of the subsequent segments 24 and the series of segments 26.

During time sequence 24, the gray bars show the time segments during which the pixel being controlled by the PWM signal is displayed, or “on.” Adding up the durations of the gray bars in sequence 24, segment 12 of 1⅛ MPW, segment 18 of 2 MPWs and segment 22 of 8 MPWs, results in a total of 11.125 MPWs. As an example, assume the pulse clock used to create the MPW pulses is 160 MHz (each MPW pulse therefore being 6.25 ns in duration). Then 1600 clock cycles are required to maintain an “on” pixel for 10 μs and 1800 cycles to maintain an “on” pixel for 11.25 μs. For a pixel to be “on” for 111.25 μs, takes 17800 clock cycles.

Looking below sequence 24, time sequences 26, 28, and 30, respectively, turn the pixel being controlled “on” for 10.875, 14.375 and 15 MPWs, respectively. A 10 μs MPW with a 160 MHz clock requires the pixel to be “on” for 17400, 23000 and 24000 clock cycles to achieve an “on” time of 108.75 μs, 143.75 μs and 150 μs, respectively.

The availability in this example of the three fractional time units, and thus fractional pulse widths, of ⅛, ¼ and ½ adds to the maximum number of possible time gradations. If the pulse sequence were strictly binary, as in the prior art, having available only integral pulse lengths such as 1, 2, 4, and 8, the maximum number of possible different pulse lengths would be 255. The fractional PWM of this invention preferably uses codes equal to or larger than MPW. Therefore, in the examples shown in FIG. 3, the smallest fractional pulse=1.125 MPW.

But the addition of fractional pulse width segments having lengths of 1⅛, 1¼ and 1½ adds many more possible codes. The maximum number of LSBs or MPWs during which a pixel can be “on” in the example of FIG. 3, provided the pixel is on during all the pulse segments shown in chain 11, is 258.875 MPWs.

As an example, assume the pulse clock used to create the MPW pulses is 160 MHz (each MPW pulse being 6.25 ns duration). Then 1600 clock cycles is required to maintain an “on” pixel for 10 μs and 1800 cycles to maintain it on for 11.25 μs. If the pixel being displayed using pulse sequence 24 were to be “on” during the gray pulses shown, 1800 clock cycles are required. If the pixel were to be “on” for the maximum possible time period, it would be “on” for a total of 258.875 MPWs or 414,200 clock cycles. Since the minimum step size is ⅛ (0.125) MPW, which is equal to 200 clock cycles, the maximum resolution can be calculated as the log₂ (258.875/0.125) or log₂ (414200/200)=log₂ (2071)=11.01 bits.

Another example of a pulse sequence 32 containing fractional pulses that can be used is: 1, 1.0625, 1.125, 1.25, 1.5, 1.75, 2, 4, 8, 16 and eight pulses of 32, for a total maximum time that the controlled pixel may be “on” of 293.6875 times the MPW. In this example, the minimum step size is 1/16 (0.0625) MPW, and the resolution is 12.18 bits, calculated as the log₂ (293.6875/0.0625)=log₂ (4699)=12.2 bits.

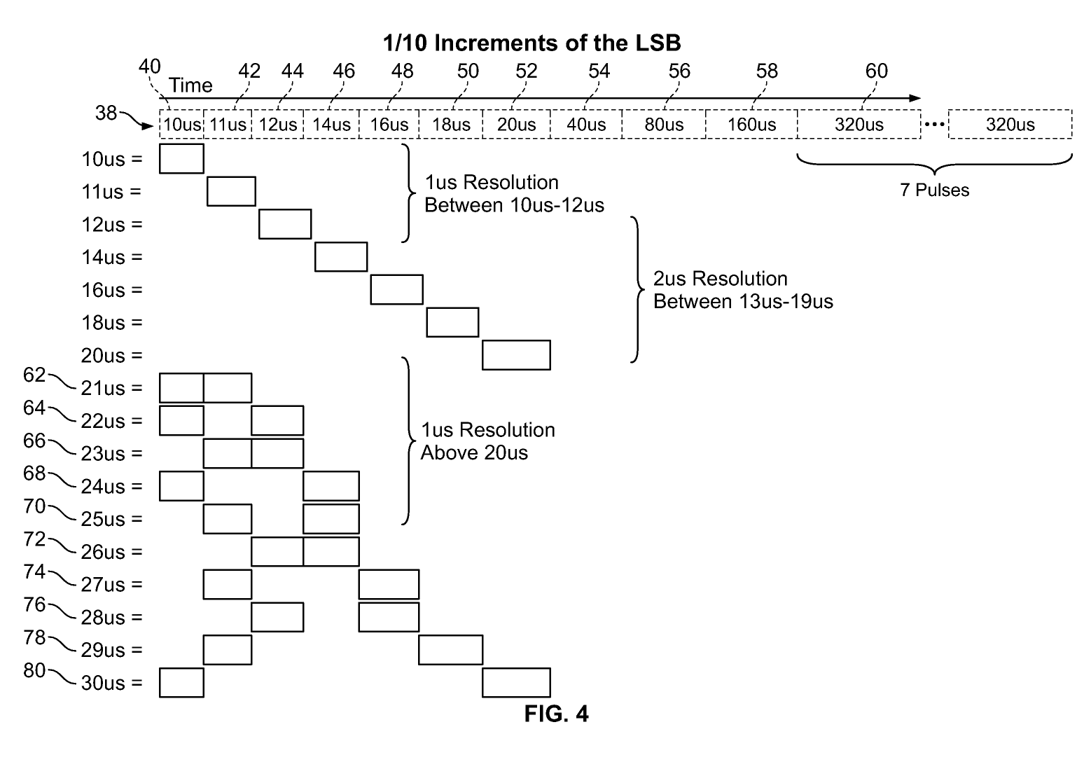

Another embodiment of the invention is shown in FIG. 4. In this embodiment, increments of 1/10 MPW are used, with an MPW of 10 μs, as shown. There are eleven unique pulses available. In the pulse chain 38 of the example, the first pulse 40 is 10 μs; the second pulse 42 is 11 μs; the third pulse 44 is 12 μs; the fourth pulse 46 is 14 μs; the fifth pulse 48 is 16 μs; the sixth pulse 50 is 18 μs; the seventh pulse 52 is 20 μs; the eighth pulse 54 is 40 μs; the ninth pulse 56 is 80 μs; the tenth pulse 58 is 160 μs; and there are seven identical pulses 60, each of 320 μs. If all the pulses in this chain were “on,” the time duration that the pixel would remain “on” totals 2621 μs, and the resolution for a 1 μs MPW is log₂ (2621)=11.35 bits, and for a 2 μs MPW is log₂ (2621/2)=log₂ (1310.5)=10.35 bits.

As illustrated in FIG. 4, additional resolution can be obtained above 20 μs by using additional fractional pulses between the 20 μs pulse and the 40 μs pulse. In this example, 21 μs, 22 μs, 23 μs, 24 μs and 25 μs pulses are used. A 21 μs pulse 62 can be obtained by using a sequence of a 10 μs pulse 40 and an 11 μs pulse 42. Similarly, a 22 μs pulse 64 can be created by a combination of pulses 40 and 44. 23, 24, 25, 26, 27, 28, 29 and 30 μs pulses are created by other combinations shown by the gray pulses in pulse chains 66, 68, 70, 72, 74, 76, 78, and 80, as shown in FIG. 4.

Using these combinations of pulses achieves a resolution, between 10 and 12 μs, of 1 μs (because there is an 11 μs pulse). However, between 13 and 19 μs, there is 2 μs resolution, as there are no 13, 15, 17 or 19 μs pulses. Above 20 μs, there is again 1 μs resolution as there is a pulse for each integer between 20 and 30 μs.

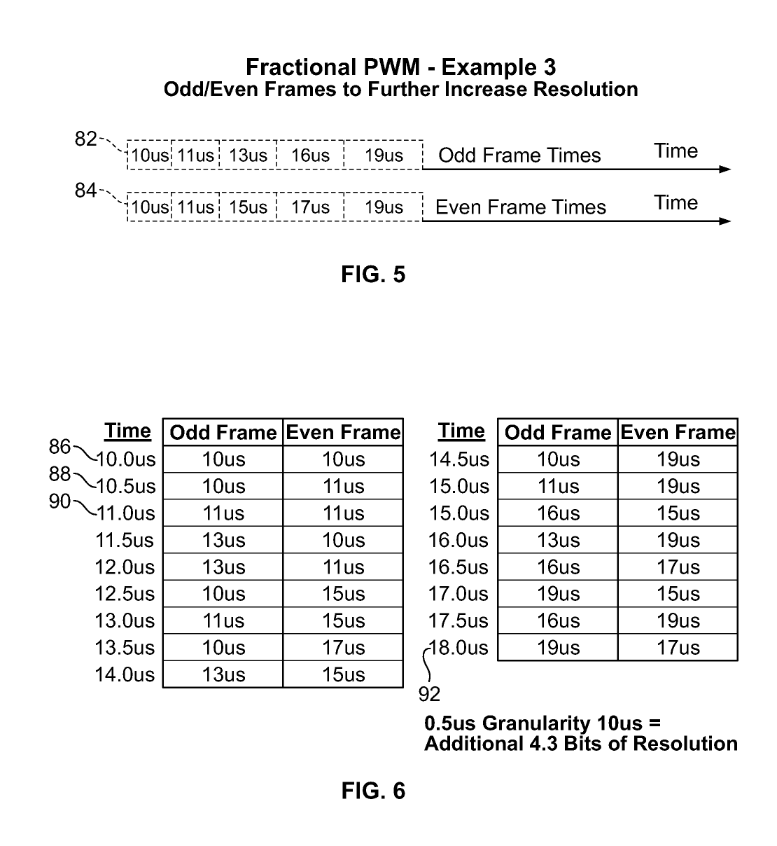

In another embodiment of the invention, display resolution can be increased further by varying the set of fractional units over time, for example, one set every other frame. As shown in FIG. 5, different fractional weightings are used for the odd and even frames. For the odd frames, a sequence 82 of 10 μs, 11 μs, 13 μs, 16 μs and 19 μs is used. For the even frames, a sequence 84 of 10 μs, 11 μs, 15 μs, 17 μs and 19 μs is used. Substituting the 15 and 17 μs pulses in sequence 72 for the 13 and 16 μs pulses in sequence 82 can increase resolution. Since one's eye averages the pixel brightness between the odd and even frames, the use of these different fractional weightings can achieve up to twice the resolution that would have been obtained if both frames used the same weightings.

Still more granularity, and thus even better resolution, can be obtained if, in addition to using different sequences of pulse widths in alternate frames, one also used different fractional weightings over time. An example of that is shown in FIG. 6 where a time sequence is illustrated with 0.5 μs time increments between 10 μs and 18 μs. Note that in the 10 μs time segment 86, both the odd and even frames are 10 μs, but in the 10.5 μs time segment 88, the odd frame is 10 μs but the even frame is 11 μs. The 11 μs time segment 90 again contains identical pulse widths, but all the remaining time segments up to and including the 18 μs time segment 92 contain different pulse widths for the odd and even frames. This additional technique of using different fractional weightings over time with an MPW of 10 μs results in a 0.5 μs granularity. The increased resolution is log₂ (10/0.5)=4.3—an additional 4.3 bits of resolution.

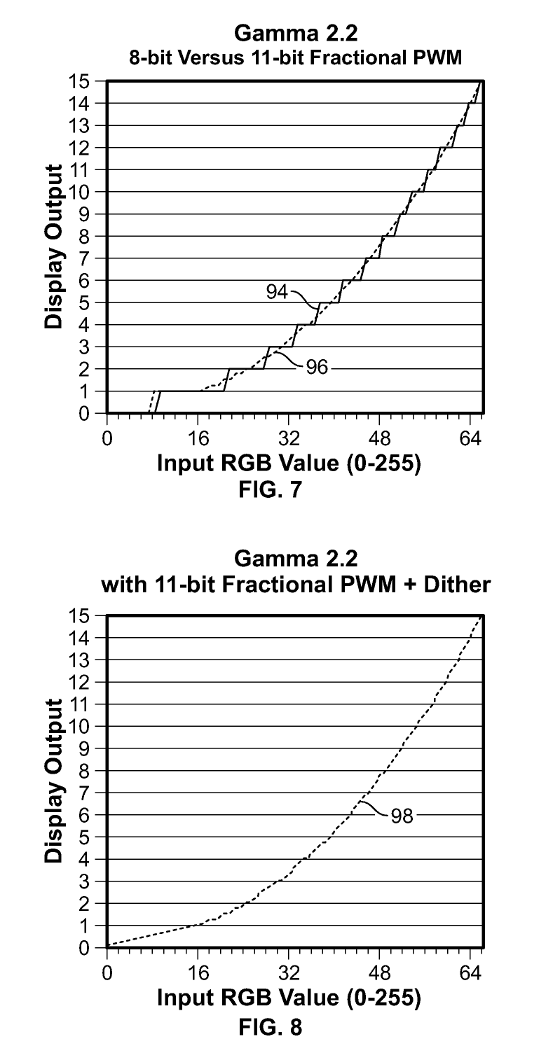

FIG. 7 illustrates the difference between mapping input RGB values of 0-255 to a linear display according to the prior art, with a mathematical 8-bit quantization of the 2.2 gamma values that provides 8-bit resolution and a jagged curve 94, and mapping the same input RGB values using the fractional PWM technique of the invention that produces the smoother curve 96 that achieves 11-bit resolution. The prior art curve 94 clearly shows the “jaggies,” whereas the curve 96 produced by the technique of the invention is much smoother. Note that there is a slight unevenness of curve 96 at the lower display output levels below about 2. This anomaly can be eliminated, or at least improved by carefully choosing the fractional PWM weightings and the temporal PWM techniques, as illustrated above, and/or by the additional use of dithering.

Dithering used with the invention can be temporal, spatial or both. Temporal dithering works well on stationary images, whereas spatial dithering works well in flat color areas, where the eye is less sensitive to the dither pattern (i.e., not flesh tones). With an LSB=1, as in the embodiment shown in FIG. 3, the fractional values 0.75, 0.5 or 0.25 are displayed. To temporally dither the pixel display to obtain, for example, a fractional value 0.5, the pixel display is changed over time according to the pattern 0-1-0-1 (or 1-0-1-0). With each time value being the LSB, the average “on” time for such a pixel over the four LSB time units is 0.5. To temporally dither a value of 0.25, a pixel is alternated according to the pattern 0-0-0-1 over time. The human visual system will integrate the pixel value over time and produce a fractional value of 0.75. As is evident to one skilled in the art, the 1s in the binary chain could be placed in various positions as long as the total “on” time for the chain is maintained.

To spatially dither an “on” value of 0.5 with a 2×2 block of pixels, the pattern

0 1
1 0
may be used. To spatially dither a value of 0.25 with a 2×2 block of pixels, the pattern
0 0
1 0
may be used.

FIG. 8 shows the same display as FIG. 7, but with 11-bit fractional PWM and with dithering only over the first 16 input RGB values that have display outputs below about 3, and are thus are the darker areas of the image. Note that curve 98 is very smooth. In these darker areas, dithering smooths out the gamma curve but is not apparent to the eye.

One of the advantages of the system of the invention is that fewer wires are required to transmit the data, thus potentially reducing the size of connectors and the area required for them on the printed circuit board. The data transfer rate can be calculated by multiplying the data clock rate times the number of data wires. For example, a data transfer rate of 100 MHz on 1 wire achieves a data transfer rate is 100 Mbits/sec. Similarly, a transfer rate of 200 MHz on 1 wire yields a data transfer rate is 200 Mbits/sec. And at 200 MHz on 2 wires, the data transfer rate is 400 Mbits/sec. Increasing the data clock speed and/or the number of signals increases the data transfer rate.

Using prior art methods in a PWM display system without the fractional PWM of the invention, the number of minimum width pulses that can be used in a given time period determines the resolution of the system. For example, to achieve 8-bit resolution in a 5000 us time period, the MPW must be no longer than 5000 us/(2⁸−1)=19.6 μs. 9-bit resolution would require an even shorter MPW of 5000 us/(2⁹−1)=9.8 μs. 10-bit resolution would require a still shorter MPW of 4.9 μs, and 11-bit resolution would require an MPW of 2.4 μs.

This fractional PWM of the invention enables 11.01 bits of resolution with 258.875 codes. In a 5000 μs time period, the MPW is 5000/258.875=19.3 μs. The data transfer rate required for a 19.3 μs MPW is only 12.6% of the data transfer rate required for a 2.4 μs MPW. Therefore if the prior art PWM requires 32 wires to transfer the data, the fractional PWM of the invention can achieve the approximately same effective resolution in most grayscale levels with only about 4 wires.

As will be apparent to those skilled in the art, many modifications to the described embodiments may be made without departing from the spirit and scope of the invention, which is to be limited only as set forth in the claims which follow.

What is claimed is:

1. A method for displaying a pixel on a display system using a plurality of pulses, comprising:
determining a minimum pulse width (MPW) capable of displaying a pixel on the display system;
defining a series of pulses for display of the pixel, at least some of the pulses having different pulse widths, at least one pulse having a pulse width which is a non-integer multiple greater than 1 of the MPW;
whereby the pixels of the displayed image can have a larger number of unique intensity levels.

2. The method of claim 1 wherein the non-integer multiple contains an integer and a fraction.

3. A method for displaying a pixel on a display system using two series of pulses, a first series interleaved with a second series, comprising:
determining a minimum pulse width (MPW) capable of displaying a pixel on the display system;
each series of pulses having at least some of the pulses in the series of different pulse widths, at least one pulse having a pulse width which is a non-integer multiple of the MPW, wherein the non-integer multiple is greater than 1, and the first and second series of pulses being different from each other, whereby the pixels of the displayed image can have a larger number of unique intensity levels and the displayed image has an improved resolution.

4. The method of displaying a pixel of claim 3 wherein the pulse width sequence of at least one of the series of pulses varies over time.

5. The method of claim 1 including the step of spatial or temporal dithering of the series of pulses.

6. The method of claim 3 including the step of spatial or temporal dithering of the series of pulses.

7. The method of displaying a pixel of claim 3 wherein the two series of pulses differ from each other.
